(19) United States
(12) Patent Application Publication
(10) Pub. No.: US 2011/0046935 A1
(43) Pub. Date: Feb. 24, 2011

(54) VIRTUAL SURGICAL TABLE

(76) Inventor: Kiminobu Sugaya, Winter Park, FL (US)

Correspondence Address: Beusse Wolter Sanks Mora & Maire, 390 N. ORANGE AVENUE, SUITE 2500, ORLANDO, FL, 32801, US

(21) Appl. No.: 12/797,572

(22) Filed: Jun. 9, 2010

Related U.S. Application Data
(60) Provisional application No. 61/185,498, filed on Jun. 9, 2009.

(51) Int. Cl. G06G 7/60

(52) U.S. Cl. 703/11

(57) ABSTRACT

Disclosed herein is a virtual surgical table that that comprises a virtual anatomical model that can be manipulated or simulated via contact by the user and/or replica surgical tools. The table embodiment is useful for presurgical simulation, simulation during the surgery, teaching and training purposes. It is also useful for virtual surgery and dissection of human and other organisms.

### CROSS-REFERENCE TO RELATED APPLICATIONS

This application claims the benefit of earlier-filed U.S. Provisional Application No. 61/185,498; filed Jun. 9, 2009.

### FIELD OF THE INVENTION

The invention relates generally to an interactive virtual system for surgical simulation. More specifically, the invention relates to surgical simulation table comprising a contact interactive display.

### BACKGROUND OF THE INVENTION

Part of surgical training comprises assisting surgeons in performing surgeries and performing surgeries during surgical residency under the supervision of a more experienced surgeon. A surgeon may be faced with a variety of different types of excisions, repairs, and other types of surgery during his/her career. Therefore, it is of great benefit to have an opportunity to perform surgeries of different types and of differing degrees of difficulty during training. Unfortunately, in many training programs there are not as many opportunities to perform certain types of surgeries as would ideally be desired. In certain parts of the country, in underdeveloped areas, and in smaller hospitals or training programs there may be fewer opportunities to assist or perform some types of surgeries.

It would be of great benefit to a surgical trainee to have an opportunity to assist with or, preferably, to perform surgeries as part of the surgical training. In some training programs, however, there are not enough of these procedures performed in the training hospital to provide an opportunity for each trainee to perform them in sufficient number to achieve a greater degree of proficiency.

### BRIEF DESCRIPTION OF THE DRAWINGS

FIG. 1 shows a top view of a virtual surgical table embodiment with a virtual anatomical model.

FIG. 2 shows a top view of a virtual surgical table embodiment with close up image.

FIG. 3 shows a side view of a virtual surgical table embodiment.

FIG. 4 shows a top view of a virtual surgical table embodiment with internal components.

FIG. 5 shows a kit embodiment with surgical tool replicas.

### DETAILED DESCRIPTION

According to one embodiment, the invention pertains to a virtual surgical table that comprises a virtual anatomical model that can be manipulated via contact by the user and/or replica surgical tools. In a specific embodiment, the virtual anatomical model is three-dimensional and includes image information of multiple layers of tissue(s) and/or organ(s) of the human body, or a nonhuman animal. The table embodiment is useful for presurgical simulation, simulation during the surgery, teaching and training purposes. It is also useful for virtual surgery and dissection of human and other organisms (i.e., designed for veterinarian training).

In one embodiment, the invention pertains to a virtual surgical table comprising a flat screen encasement, an interactive screen interface, a computer processor module one or more computer program code modules, and a storage medium with a plurality of medical images stored thereon.

To construct the virtual anatomical model, a 3D image model is reconstructed from MRI, CT and other medical imaging then segmented. The segmented 3D image is dressed with a color overlay or color image processing, often referred to as “skin” in the computer science field, to resemble of each tissue or organ so that it looks like real tissue. In one embodiment, the virtual anatomical model is engineered to have flexibility, stretch ability, water contents and mass weight characteristics corresponding to each tissue to make each organ look and be manipulated so as to provide a more life-like handled. In addition, virtual surgical table is configured so as to enable the operator to rotate the table into any direction and can slice at any angle. In a specific embodiment, the transparency of layers of the anatomical model thereby enabling the operator to look inside of the tissue or organ without slice of cut into it.

In a specific embodiment, the interactive screen interface is configured to interact with the user via touch/contact whether by the finger/hand contact or through contact with the surgical tool replicas. The virtual surgical table is equipped with one or more processor modules and program code modules that will virtual surgical activity executed by the operator. For example; the images of the virtual anatomical model can be moved by fingers and hand. When the operator picks up a scalpel replica, for example, the virtual surgical table will recognize it, and its tip will appear on the 3D image. The virtual surgical table will create incisions in the anatomical model as the operator makes incisions. When the operator picks up a pair of scissors the table will recognize it, its tip is appears on the 3D image and the operator can make a cut. When the operator inserts a catheter, it will appear in the 3D image and be simulated according to the operator's manipulation. The operator can adjust the transparency of the skin to see the catheter inside of the tissue. If it is necessary, rotation and slicing can be applied with this visualization purpose. When the operator inserts probes, they will appear in the 3D image and be simulated according to the operator's manipulation. The operator can adjust the transparency of the skin to see the probes inside of the tissue. If it is necessary rotation and slicing can be applied with this visualization purpose so that the operator can insert the probes in the virtual anatomical model in an optimal condition.

Furthermore, the virtual surgical table is programmed to simulate dynamics of internal organs and tissues of a live patient, such as but not limited to blood circulation and tissue movement characteristics within the model. For example, if during surgical procedure a vein is accidentally cut, bleeding will result as will be shown on the screen interface. In the example of heart surgery, the table will simulate movement of the body associate with the heartbeat.

In another embodiment, a virtual anatomical model is produced image data from a specific patient for a specific procedure. This will enable optimizing the surgical procedure and/or practice runs of the surgery contemporaneous to or prior to conducting a surgery. Considerable benefits include, but are not limited to, minimizing damage from the surgery, reducing the time for the surgery, reducing the risk of the surgery, reducing the exposure of the patient to x-ray and other potentially hazardous environments.

The virtual surgical table embodiment may be movable such as to be rotatable, and/or pivotable. Ideally, the table is movable with at least 3 degrees of freedom.

The system and method embodiments will be particularly helpful in teaching, practicing, and evaluating surgical techniques. The system and method may be used in a variety of settings, including surgical residency programs, continuing medical education programs, and seminars and conferences where new surgical techniques are taught. The system also provides advantages, in terms of interchangeability of parts and cost-effectiveness, for use in both teaching and in testing and certification programs.

In another embodiment, the invention pertains to a virtual surgical table that comprises a screen encasement, an interactive screen interface, a computer processor module, a memory component; a virtual anatomical model comprised of segments of images stored on said memory component; one or more computer program codes modules stored on said memory component. The one or more computer program code modules enable the virtual surgical table to display the virtual anatomical model or portion thereof, to achieve one or more of the following actions: to effectuate the creation of a virtual incision into the virtual anatomical model, to move or stretch a portion of the virtual anatomical model, to virtually cauterize a portion of the virtual anatomical model, to virtually apply forceps to a portion of the virtual anatomical model, to virtually insert a catheter into a portion of the virtual anatomical model, or to virtually insert a scope into a portion into the virtual anatomical model. The virtual surgical table enables the operator to access internal organs and tissues according to known surgical procedural steps. The term “virtual” or “virtually” as it relates to executing an operation that involves manipulation of the virtual anatomical model means that the operation occurs on the virtual anatomical model and is depicted graphically on the screen interface.

According to a more specific embodiment, each surgical operation step is mediated by contacting the screen interface directly (touch or proximal movement of a finger or hand of the operator), or is mediated indirectly through implementation of a surgical tool replica. In a more specific embodiment, the surgical operation steps are executed in response to contacting the screen interface. In an alternative embodiment, each operation step is mediated without touching the interactive screen interface. According to a more specific embodiment, the virtual surgical table of claim 1, wherein the creation of a virtual incision is responsive to a scalpel replica that moves across the interactive screen interface in proximity to the interactive screen but without contacting the interactive screen. The table may comprise one or more sensors that detect the proximity of a particular surgical tool replica. This may be a an indicator (magnet, RF transmitter, RFID, infrared device) associated with a particular surgical tool or replica. The interactive screen interface may display a structure corresponding to the surgical tool when it is brought into proximity with the interactive screen interface. This may be a cursor, or a movable structure representing a portion or full rendition of the surgical tool being used. Proximity with the screen interface comprises 3 feet or closer to the screen interface without touching.

According to another embodiment, the invention pertains to a kit that comprises two or more surgical tool replicas that include contact points for interaction with the interactive screen interface without damaging the interactive screen interface. The surgical tool replicas may include, but are not limited to, a scalpel, a catheter, forceps, an electrocautery instrument, scissors and/or an endoscope. The surgical tool replicas may be comprised of plastic, metal, glass, ceramic or wood, and some configuration that incorporates more than one material. In a specific embodiment, the surgical tools are made of plastic. The kit and the virtual surgical table may be sold as an article of manufacture.

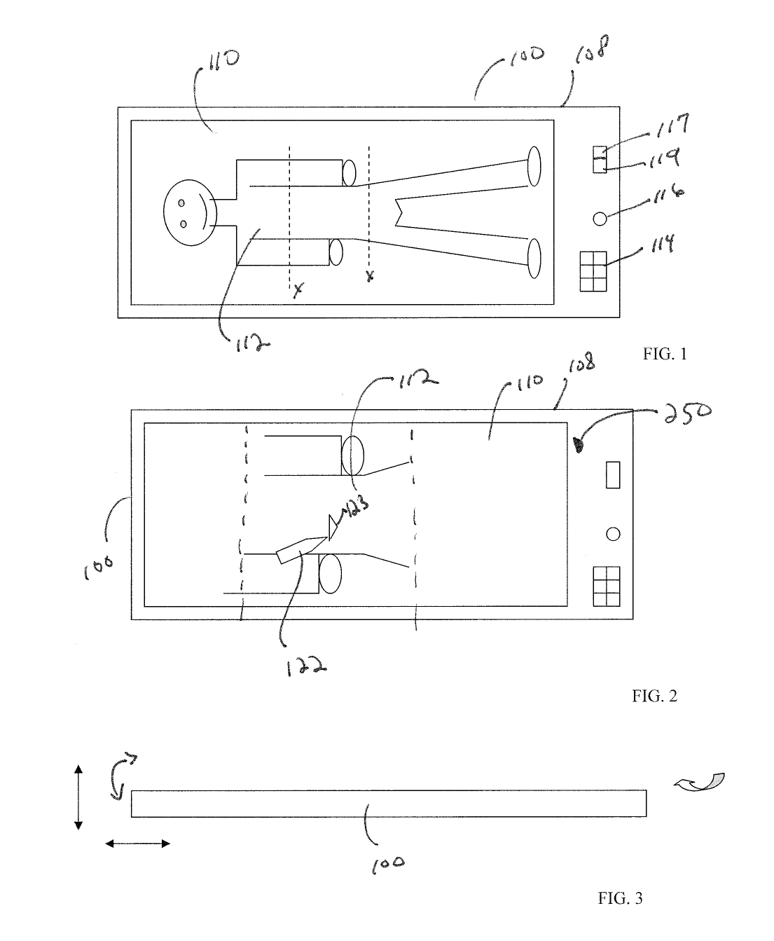

Turning to the drawings, FIGS. 1 and 2 show a top view of a virtual surgical table embodiment 100 that include a screen encasement 108 that houses an interactive screen interface 110. The table 100 includes a control panel 114, a power switch 116, and input/output ports 117 and 119. The control panel 114 allows for interaction with the table with optional functionality that complements interactivity of the screen interface 110. For example, certain operations may be conducted duplicative to, in complement to, or in place of operations conducted via interaction with the interactive screen interface 110, including but not limited to, moving the anatomical model, selecting deeper levels of tissue, selecting successive steps of a given surgical procedure with different view of the anatomical model, selecting transparency of the of a portion or layer of the anatomical model, etc. Displayed on the interactive screen interface 110 is a virtual anatomical model 112. FIG. 2 shows a zoomed in view of the anatomical model 112 between dashed lines (x-x in FIG. 1). Also, FIG. 2 shows the implementation of a scalpel replica 122. As the scalpel replica 122 moves across the it creates a virtual incision 123 on the virtual anatomical model 112.

FIG. 3 shows a side view of the virtual surgical table 100. FIG. 3 shows the movement options of the table 100 as indicated by the arrows. The table 100 may pivot, rotate, move horizontally, and move vertically.

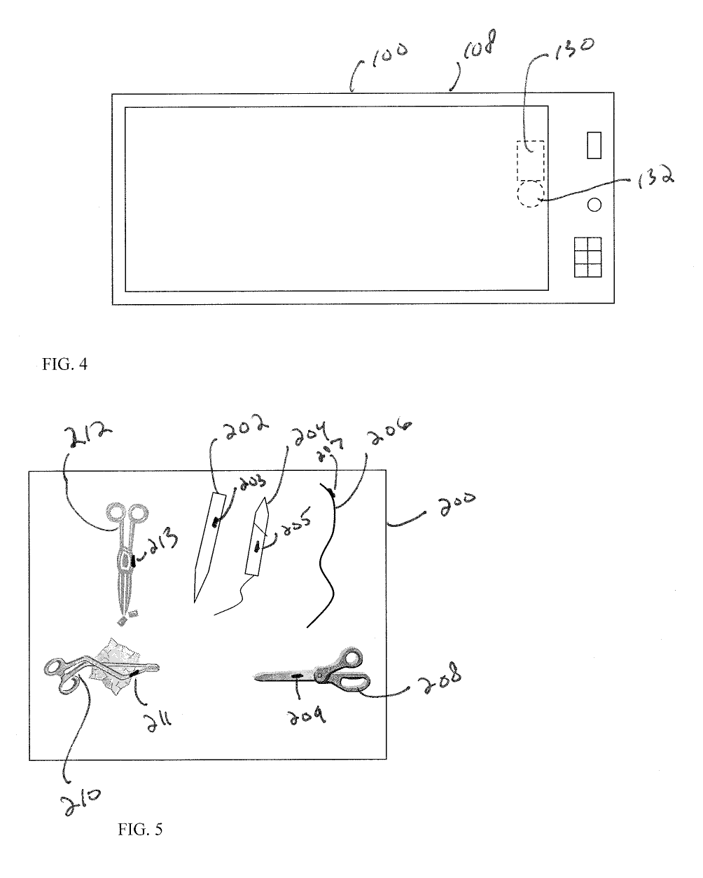

FIG. 4 shows the table 100 without an image displayed and reveals a processing module 132 and memory component 130 housed within the encasement 108.

FIG. 5 shows a kit 200 comprising a series of surgical tool replicas, including a scalpel 202, an electrocautery device 204, a catheter 206, surgical scissors, 208, forceps 210, and 212. Associated with each replica are indicators 203,205, 207, 209, 211, and 213 respectively. These indicators are detected by sensor 250 shown on FIG. 2.

The image data implemented by virtual surgical table embodiment may include a virtual anatomical model derived from images such as those obtained from, but not limited to, x-ray, magnetic resonance imaging (MRI), pet scan, ultrasound, optical coherence topography (OCT), intravascular ultrasound (IVUS), fluoroscopy, as well as images of histological sections. See, e.g., U.S. Patent Publication 20080288450 and 20100077358 for information concerning the production of 3D models from medical images. Image Registration techniques may be used when needed to align the images with each other. Spatial transformations alter the spatial relationships between pixels in an image by mapping locations in an input image to new locations in an output image. In Image registration typically one of the datasets is taken as the reference, and the other one is transformed until both datasets match. This is important as images must be aligned to enable proper 3D reconstruction for quantitative analysis. In a specific embodiment, the system includes a registration module that provides an affine registration, i.e. it determines an optimal transformation with respect to translation, rotation, anisotrope scaling, and shearing.

A number of patents exist which relate to medical software for physicians, including, U.S. Pat. Nos. 7,426,475; 7,072,840; 5,737,539; 5,845,255; all of which are incorporated herein by reference. Several projects related to 3D-imaging are TeleMed-VS, 3D-Slicer, 3D-DOCTOR, PACS, and OsiriX. The projects related to 3D-imaging attempt to solve the challenge of medical 3D-imaging by storing large 3D-image files (image files composed of multiple 2D images) and manipulating such files through the use of graphical libraries. Creating a 3D anatomical model from multiple 2D images can utilize the information in the aforementioned patents and software products. Also, Xu et al., Health Physics Society, 78:476-486 (2000) is cited for an example of a 3D model that can be adapted according to the teachings herein to carry out the manipulation and surgical simulation features discussed herein.

A true image format is desired to accurately store an image for future editing. Choosing the most appropriate true image format from dozens of existing formats is important for the success of certain system embodiments. On a computer monitor, images are nothing more than variously colored pixels. Certain image file formats record images literally in terms of the pixels to display. These are called raster images, and they can only be edited by altering the pixels directly with a bitmap editor. Vector image files record images descriptively, in terms of geometric shapes. These shapes are converted to bitmaps for display on the monitor. Vector images are easier to modify, because the components can be moved, resized, rotated, or deleted independently. Every major computer operating system has its own native image format. Windows and OS/2 use the bitmap (BMP) format, which was developed by Microsoft, as the native graphics format. BMP tends to store graphical data inefficiently, so the files it creates are larger than they need to be. Although Mac OS can handle any kind of format, it is preferential to the PICT format, which more efficiently stores graphical data. Unix has less of a standard, but X Windows and similar interfaces favor XWD files. All of these formats support full 24-bit color but can also compress images with sufficiently fewer colors into 8-bit, 4-bit, or even 1-bit indexed color images. However, one disadvantage of file compression is the occasional loss of image quality. Tagged image file format (TIFF) is a “loss-free”, 24-bit color format intended for cross platform use, and tends to be accepted by most image editors on most systems. TIFF can handle color depths ranging from one-bit (black and white) to 24-bit photographic images. Although, like any standards, the TIFF developed a few inconsistencies along the way; but nevertheless, this format is a good format to store the original 2D data of certain system embodiments.

A number of patents describe techniques for visual representation of organs or of functional systems involving related organs, such as WO2004/068406, WO2005/119578, U.S. Pat. No. 6,236,878 and WO2006/000789. It would be advantageous, to integrate a plurality of adjacent organs in a biophysical depiction or model. It would be even more advantageous if an integrated anatomical model could contemplate and depict dynamic functions and interactions of all the organs in a modeled subject (a model representative of real body anatomy of a subject, distinct from the anatomy of other possible subjects) with functional components (e.g. muscle action, lung function, heart function etc.) wherein the functional components interact.

An exemplary system for implementing the invention includes a computing device or a network of computing devices. In a basic configuration, computing device may include any type of stationary computing device or a mobile computing device. Computing device typically includes at least one processing module and memory component. Depending on the exact configuration and type of computing device, system memory may be volatile (such as RAM), non-volatile (such as ROM, flash memory, and the like) or some combination of the two.

The term “processing module” may include a single processing device or a plurality of processing devices. Such a processing device may be a microprocessor, microcontroller, digital signal processor, microcomputer, central processing unit (CPU), field programmable gate array (FPGA), programmable logic device, state machine, logic circuitry, analog circuitry, digital circuitry, and/or any device that manipulates signals (analog and/or digital) based on operational instructions. The processing module may have operationally coupled thereto, or integrated therewith, a memory device. The memory device may be a single memory device or a plurality of memory devices. Such a memory device may be a read-only memory, random access memory, volatile memory, non-volatile memory, static memory, dynamic memory, flash memory, and/or any device that stores digital information.

As will be appreciated by one of skill in the art, certain examples of the present invention may be embodied as a device or system comprising a processing module, and/or computer program product comprising at least one program code module. Accordingly, the present invention may take the form of an entirely hardware embodiment or an embodiment combining software and hardware aspects, commonly known as firmware. As used herein, firmware comprises a computer program module that is embedded in a hardware device, for example a microcontroller. It can also be provided on flash memory or as a binary image file that can be uploaded onto existing hardware by a user. As its name suggests, firmware is somewhere between hardware and software. Like software, it is a computer program which is executed by a microprocessor or a microcontroller, but it is also tightly linked to a piece of hardware, and has little meaning outside of it.

System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device. Computing device may also have input device(s) such as a keyboard, mouse, pen, voice input device, touch input device, etc. Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Many types of input devices are presently available for performing operations in a computing system, such as buttons or keys, mice, trackballs, joysticks, touch sensor panels, touch screens and the like. In a preferred embodiment, the virtual surgical table pertains to a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Single-sided mutual capacitance touch sensor panels typically include a plurality of sense elements distributed across a substrate. Each sense element is separated from an associated set of drive elements by a distance sufficient to enable the sense element to detect when a stimulating voltage has been applied to a particular drive element. When a finger, stylus, or other conductive element is situated proximate to a particular region of the touch sensor panel, a portion of the charge driven by the stimulating voltage escapes via the conductive pathway formed by the finger, stylus, or other conductive element. The amount of charge coupling detected by the sense element is therefore reduced relative to the amount of charge coupling that would be detected absent the conductive pathway. A touch region can then be calculated based upon determining which sense elements have transmitted reduced signals for a particular sensed period.

Computer program code modules for carrying out operations of certain embodiments of the present invention may be written in an object oriented, procedural, and/or interpreted programming language including, but not limited to, Java, Smalltalk, Perl, Python, Ruby, Lisp, PHP, “C”, FORTRAN, Assembly, or C++. The program code modules may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Functions of the computer as described herein can be implemented by computer-readable program code modules. These program code modules may be provided as part of firmware and/or computer-readable memory, or otherwise provided to a processing module of a general purpose computer, special purpose computer, embedded processor or other programmable data processing apparatus to produce a machine, such that the program code modules, which execute via the processing module of the computer or other programmable data processing apparatus, or as part of firmware, create means for implementing specified functions.

These computer program code modules may also be stored in a computer-readable memory that can direct a computer or other programmable data processing apparatus to function in a particular manner, such that the program code modules stored in the computer-readable memory produce an article of manufacture.

The computer program code modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing predetermined functions.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It should be understood that the examples and embodiments described herein are for illustrative purposes only and that various modifications or changes in light thereof will be suggested to persons skilled in the art and are to be included within the spirit and purview of this application. References cited herein are incorporated in their entirety to the extent not inconsistent with the teachings herein.

What is claimed is:

1. A virtual surgical table that comprises a screen encasement, an interactive screen interface, a computer processor module, a memory component; a virtual anatomical model comprised of segments of images stored on said memory component; one or more computer program codes modules stored on said memory component, wherein the one or more computer program code modules enable the virtual surgical table execute one or more of the following operations:
(i) to display the virtual anatomical model or portion thereof,
(ii) to effectuate the creation of a virtual incision into the virtual anatomical model,
(iii) to move or stretch a portion of the virtual anatomical model,
(iv) to virtually cauterize a portion of the virtual anatomical model,
(v) to virtually apply forceps to a portion of the virtual anatomical model,
(vi) to virtually insert a catheter into a portion of the virtual anatomical model, or
(vii) to virtually insert a scope into a portion into the virtual anatomical model.

2. The virtual surgical table of claim 1, wherein the virtual anatomical model is derived from medical image data from a single subject.

3. The virtual surgical table of claim 1, wherein the interactive screen interface is responsive to contact by an operator.

4. The virtual surgical table of claim 1, wherein the creation of a virtual incision is responsive to a surgical tool replica that contacts and moves across the interactive screen interface, wherein the surgical tool replica is a scalpel.

5. The virtual surgical table of claim 1, wherein the creation of a virtual incision is responsive to a scalpel replica that moves across the interactive screen interface in proximity to the interactive screen but without contacting the interactive screen.

6. The virtual surgical table of claim 5, wherein said table comprises a sensor that senses an indicator associated with the scalpel replica.

7. The virtual surgical table of claim 6, wherein said interactive screen interface displays a structure corresponding to the scalpel replica when the scalpel replica is brought into proximity with the interactive screen interface.

8. The virtual surgical table of claim 7, wherein proximity with the screen interface comprises 3 feet or closer to the screen interface without touching.

9. The virtual surgical table of claim 1, wherein each operation step (II)-(vii) is mediated by contacting the screen interface directly, or is mediated indirectly through implementation of a surgical tool replica.

10. The virtual surgical table of claim 9, wherein contacting the screen interface directly is mediated by touch by a finger or hand of an operator.

11. The virtual surgical table of claim 1, wherein each operation step (II)-(vii) is mediated by directly, or is mediated indirectly through implementation of a surgical tool replica, without touching the interactive screen interface.

12. The virtual surgical table of claim 1, wherein a portion or layer of the virtual anatomical model is selectively transparent.

13. An article of manufacture comprising the virtual surgical table of claim 1, and a kit comprising at least one surgical tool replica that includes a contact surface for touching and/or sliding across the interactive screen interface without damaging the same.

14. The article of manufacture of claim 13, wherein at least one surgical tool replica comprises a scalpel, a catheter, forceps, an electrocautery instrument, scissors or an endoscope.

15. The article of manufacture of claim 13, wherein the at least one surgical tool replica is comprised of plastic, metal, glass, ceramic or wood, and a combination thereof.

16. The article of manufacture of claim 13, wherein the virtual surgical table includes a sensor that senses the at least one surgical tool.

17. The article of manufacture of claim 16, wherein the at least one surgical tool comprises an indicator.

18. The article of manufacture of claim 13, wherein the at least one surgical tool comprise a plurality of surgical tools and said virtual table senses a particular surgical tool when brought into proximity therewith.

19. A method of conducting a surgical simulation, said method comprising
obtaining a virtual surgical table according to claim 1; and
effectuating one of the following operations on the virtual anatomical model:
(i) creating a virtual incision into the virtual anatomical model,
(ii) moving or stretching a portion of the virtual anatomical model,
(iii) cauterizing a portion of the virtual anatomical model,
(iv) applying forceps to a portion of the virtual anatomical model,
(v) inserting a catheter into a portion of the virtual anatomical model, or
(vi) inserting a scope into a portion into the virtual anatomical model
